(19) United States
(12) Patent Application Publication
(10) Pub. No.: US 2010/0131558 A1
(43) Pub. Date: May 27, 2010

(54) SYSTEM AND METHOD FOR MANAGING COPYRIGHT LICENSING

(76) Inventors: James D. Logan, Candia, NH (US); Geoffrey Blanding, Bow, NH (US); Daniel Opalacz, Glastonbury, CT (US)

Correspondence Address: LOGINOV & ASSOCIATES, PLLC, 10 WATER STREET, CONCORD, NH, 03301, US

(21) Appl. No.: 12/273,675

(22) Filed: Nov. 19, 2008

(51) Int. Cl. G06Q 10/00; G06F 17/30; G06F 7/00

(52) U.S. Cl. 707/783; 705/7

(57) ABSTRACT

A system and method for storing and managing copyright licensing. There is provided a device for monitoring a business's performance of music or other copyrighted works to determine if the business has a license for performing the works. The device is generally employed by a user to record a sample of the work, as well as identifying information about the business, to assist in determining the licensing status of the business. A business location identification process obtains the information gathered from the device to identify the business where the device is located. A copyrighted work identification process obtains the recording of the copyrighted work from the device and identifies the particular copyrighted work. The business information is transmitted to a copyright license database that determines the licensing status of the business. If the business is not on the list, the business name is transmitted to a database of unlicensed businesses.

### FIELD OF THE INVENTION

The present invention relates generally to the field copyright licensing and more particularly to the management of copyright licensing in connection with businesses that display and/or perform copyrighted works.

### BACKGROUND OF THE INVENTION

Restaurants, bars, stores, and other businesses routinely play copyrighted music, movies, or television on their premises or over their phone systems when users are on hold. These “performances” add to the customers' experience, and enhance the value of the primary service, offered by the business.

Businesses are not allowed to simply play audio or movie works from, for example, a CD or DVD over the air in order to entertain customers. Nor are businesses allowed to play copyrighted music over phone systems or satellite radio on their premises, or even terrestrial radio under particular circumstances. Since such media is copyright protected, businesses are legally required to purchase a license, either from the copyright holder or from a copyright licensing organization. Many business owners, whether as a result of ignorance of the law or in a conscious attempt to avoid paying the necessary licensing fees, still play music without acquiring the necessary license.

Such unauthorized public performance costs copyright holders millions of dollars a year. While music licensing organizations collect approximately $100 million a year from businesses playing copyrighted content, there are likely thousands and possibly hundreds of thousands of unlicensed businesses that play music formatted, for example, in CDs and MP3s without any thought of purchasing a license, whether willfully or due to ignorance. Such infringements result in millions of dollars of unrealized revenue for copyright holders of songs. In addition, unauthorized performances of motion picture are estimated by the MPAA to cost the film industry somewhere between one and two million dollars annually.

The rights to public performances of music and movies are typically controlled and sold by copyright licensing organizations. For music, such organizations include Broadcast Music, Incorporated (BMI), the American Society of Composers Authors and Publishers (ASCAP), and the Society of European Stage Author and Composers (SESAC). Movie-licensing companies include Swank Motion Pictures and the Motion Picture Licensing Corporation (MPLC). In addition, satellite radio must license business use separately from that of consumers. These associations and businesses are responsible for policing thousands of public venues nationwide and ensuring that businesses do not perform media for which they do not have a license.

Licensing organizations often employ a national network of undercover agents to investigate businesses, and ensure that they only play media to which they have purchased the rights. Even the agents employed by ASCAP, however, cannot hope to be everywhere and to catch every copyright infringer.

There is an opportunity, therefore, to empower ordinary citizens to aid in the verification of the licensing status of businesses playing copyrighted material as they visit stores, restaurants, and clubs or bars helping to report businesses operating without a license and to bring them into compliance with copyright law. This arrangement should allow for easy and accurate verification of status and result in increased licensing revenue for copyright holders.

### SUMMARY OF THE INVENTION

This invention overcomes disadvantages of the prior art by providing a system and method for storing and managing copyright licensing. In general, the invention herein provides a system and method for individuals to determine the licensing status of a business that is performing copyrighted works using various commonly available communication media, such as cellular telephones and other mobile devices.

The licensing status of a business can be used to determine if there are any unauthorized or unlicensed performances occurring, or that have occurred, at the business in question. If an unlicensed performance has occurred, this information is used to create a report that includes all information necessary to identify the unlicensed business, as well as the copyrighted work that is being performed. This report can be used to reward the user that reported the unauthorized use, or to bill the business for its use.

In an illustrative embodiment, a user or other individual can employ one of a plurality of devices, such as a phone, mobile device, or laptop/desktop computer, to determine the licensing status of a business. These devices can be in communication through the public Internet and/or other network (a cellular network, for example) with a business location identification process, which determines the business name based on GPS coordinates from the device, or from additional user input. The devices can also be in communication with a media identification process that identifies the particular copyrighted work that is being played or otherwise performed.

In an illustrative embodiment, there is also provided a Copyright License Database (CLD) which has stored therein licensing data for a plurality of businesses, as well as data from the various Performance Rights Organizations. This database, in essence acts as a hub of activity or clearing house within the overall system connecting businesses, copyright holders and reporting patrons/individuals of the business. It operates in connection with one or more data servers that pass information on copyrights, business and the like between interested parties. These Performance Rights Organizations are responsible for the licensing of copyrighted works, including music, movies, and any other work of authorship that can be copyrighted. The CLD that stores the licensing information is in communication with a server application that obtains the licensing status of a particular business and then determines if an unauthorized performance has occurred. If there is an unauthorized or unlicensed use, the server application can forward this information to a Database of Unlicensed Businesses (DUB). Both the CLD and the DUB can be publicly available, searchable, and published so as to allow a user to readily determine the licensing status of a particular business.

By enabling organizations such as ASCAP, BMI, or SESAC to rely on public “enforcement” agents, this will allow licensing organizations to reduce the administrative and investigative costs of uncovering and pursuing copyright infringement claims. This enhanced ability to locate infringers can allow copyright holders to recoup some or all of the millions of dollars in revenue lost due to unlicensed public performances of copyrighted content.

Also, by offering the threat that any customer can potentially be working for licensing organizations and enforcing copyrights, the invention will increase the number of establishments who willingly become licensees of copyrighted content. Faced with the possibility that they will certainly be caught if using unlicensed media, business owners will have to purchase licenses. This will thus increase copyright holders' revenue while decreasing the cost of detecting and punishing copyright violations. It will also create a more level playing field for businesses, as each will be paying their fair share to support the music industry.

### BRIEF DESCRIPTION OF THE DRAWINGS

The invention description below refers to the accompanying drawings, of which:

FIG. 1 shows a block diagram of the general architecture of an illustrative system for managing copyright licensing;

FIG. 2 is a flow chart of an illustrative procedure for managing copyright licensing;

FIG. 3 is a business license listing showing an exemplary set of data that is stored for a business within a copyright licensing database according to an illustrative embodiment;

FIG. 4 is an exemplary CLD showing data for a plurality of licensing authorities according to the illustrative embodiment;

FIG. 5 is a flow chart of an illustrative process for automated business licensing according to an illustrative embodiment;

FIG. 6 is a flow chart of an illustrative process for ambient playlist generation according to an illustrative embodiment;

FIG. 7 is a flow chart of an illustrative process for the ex post licensing of copyrighted materials;

FIG. 8 is a block diagram showing the software to allow for filtering of songs to determine which particular licensing authority is affiliated with the song, according to an illustrative embodiment;

FIG. 9 is a flow chart showing the process by which a user reports an unlicensed performance of copyrighted works according to an illustrative embodiment; and

FIG. 10 is a flow diagram showing the process by which the illustrative system performs lyrics and dialogue text matching, according to an illustrative embodiment.

### DETAILED DESCRIPTION

In accordance with the present invention there is provided a system and method for storing and managing copyright licensing. More particularly, there is provided a system and method for determining the status of a business performing copyrighted works and, if desired, reporting on unlicensed performances of the copyrighted works.

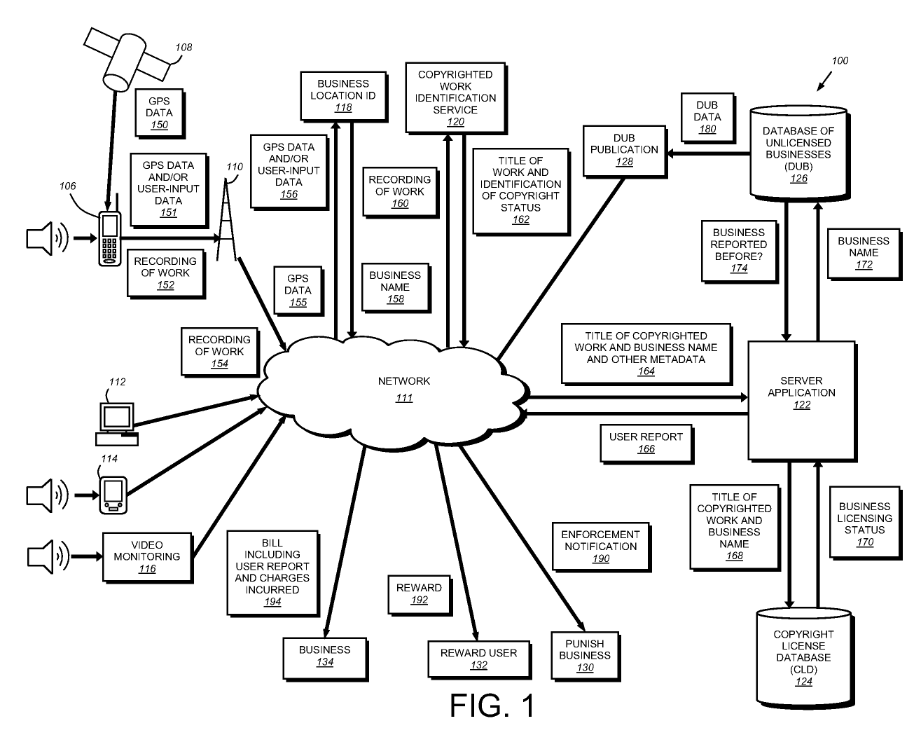

FIG. 1 is a block diagram showing the general architecture of an illustrative system 100 for managing copyright licensing including a Copyright License Database (CLD) 124, for storing the copyright licensing information. The CLD, provides a vehicle for the general public to determine and report unlicensed public performances of copyrighted music, movies, television and other copyrightable content. The CLD is in communication with a plurality of voluntary, independently operating individuals, or users (patrons of the business, for example), that are equipped with a plurality of appropriate devices, such as ordinary cellular or land line phones, ‘smart’ phones 106, mobile devices 114, or computers 112. Using these devices, along with the CLD, individuals such as agents employed by Copyright Licensing Organizations to determine if any businesses are performing without a license, will be able to monitor the licensing status of a restaurant, store, bar, or other public establishment as they go about their day-to-day lives.

The CLD may reside on one or more storage locations. It can be organized in any acceptable manner for organizing the CLD database data (such as an SQL format). The CLD and its associated data server can be owned by a separate entity and/or by one or more copyright holders. The overall system herein can be interchangeably termed the “CLD”.

In an illustrative embodiment, a user (i.e. any individual desiring to check up on a business's licensing status) can employ any appropriate device (such as 106, 112, 114 or 116) that is in communication with a CLD to report any unauthorized “performances”. The user enters GPS or other identifying information which is transmitted through the Internet 111 to a Business Location Identification process 118 which determines the name of the business to be used in ascertaining whether the business has been playing or otherwise performing copyrighted works without a license.

Users employing the GPS function of a mobile device (“MD”) are able to establish the identity of a business they wished to look up in the CLD, and in which they were located at the time. To implement this GPS capability, the CLD would add the latitude and longitude, or other geographic-type information, to the listing of each business premises in the database. This data can be generated using a service such as that provided by the online service provider, Geocoder.US, which can provide the latitude and longitude for any address which a user inputs.

To search the CLD for a business using the GPS data, an MD 106 will receive the present GPS coordinates from a satellite 108 via data stream 150 and transmit this GPS data to a cellular tower 110 via data stream 151 and then to the Internet 111 via data stream 155. Alternatively, a user may manually input data to identify the business location, and either the GPS data or user-input data is transmitted to a business identification service 118 via data stream 156, which provides the business name via datastream 158.

While not shown, it is contemplated that the system can return various information to the user's device via a return path using the same data transmission and receipt mechanisms (e.g. cellular communication) as the sending path data streams described in FIG. 1.

Based on receiving these GPS coordinates, the CLD can present one or more businesses that might reside at that location. The business identification service has capabilities to search the “yellow pages” or other online business listings and attempt to correspond the name of the business based upon the GPS coordinates. The user can confirm the business' identity, by entering other metadata related to the business, such as a street name, picture, or description.

Based upon current limitations on the effectiveness of GPS reception indoors, the GPS reading used to search the CLD can be the last accurate GPS reading taken by the device, such as a reading immediately outside the entranceway to a mall. This reading is saved in the MD and transmitted later to the CLD, to thereby provide a more accurate GPS reading.

A recording of the particular work is obtained by the user device, which is transmitted to the cell tower 110 via data stream 152, and then through the cell tower 110, the recording is transmitted to the Internet 111 via data stream 154. The Internet 111 transmits this recording of the work to a Copyrighted Work Identification Service 120, which identifies the particular work and whether it is copyrighted. This information is transmitted to the Internet 111 via data stream 162. The Copyrighted Work Identification Service 120 is applicable to any copyrighted work, regardless of the media, and includes songs, movies, television broadcasts, copyrighted art, drawings, photos, and many other works. The identification of the media, along with the business name associated with performing said media, is transmitted to a server application 122 that transmits this information to the CLD 124, which obtains the licensing status of the business and transmits this information back to the server application.

The Copyrighted Work Identification Service can be implemented, for example, using a commercially available, independent service that can detect the particular song/artist (or video) from a fragment of the sound using conventional audio recognition processes. One such service is the music recognition engine Shazam provided by Shazam Entertainment of London, England.

A user can collect data via a mobile device 114, and then upload such information later while interacting with a CLD online reporting form. Alternatively, users can employ a browser on the mobile device to directly input data into such a form in real time. Reports can even be submitted via a phone call to a person or automated attendant. Lastly, a reporting application can reside on the mobile device itself. Such an application would have the advantage of directly capturing metadata concerning time, location (based on GPS readings), song recordings and any other information relevant to determining if a business is performing copyrighted works without a license.

The rights to public performance of copyrighted works is generally controlled and sold by copyright licensing organizations that pass revenue therefrom on to the individual artists and production companies. Currently there exist a plurality of well-known copyright licensing organizations, including BMI, ASCAP, SESAC and MPLC, among others. Businesses generally obtain flat-rate licenses from multiple organizations. In some cases, an establishment may contract with one licensing agency but not the others. In other cases, live performances of original music, copyrighted music not represented by a licensing organization, or music with no copyright may all be played. In each case the performance of a given song might present different infringement consequences at any given venue. As such, the identification of the specific copyrighted work being performed becomes significant.

Generally, after an agent detects a violation, warning notices that licensing organizations typically send to businesses that violate an owned copyright detail a specific complaint, listing, for example, a song or multiple songs that were played at a specific time on a specific date. Reporting this detailed information, rather than only stating that a business was playing unlicensed music, tends to particularize a complaint and usually causes infringing businesses to respect, and abide by, infringement notifications. In addition, compiling detailed data about what specific content was infringed, and when, provides a stronger case for the licensing organization involved to use against the business, should litigation ensue.

The source of the music is a significant data item for the CLD. In addition, the CLD should be able to differentiate radio broadcasts and television broadcasts that can be license-free in some circumstances. In some cases, an establishment may play songs in such a manner that it is unclear to a listener if the music is coming from locally generated sources (such as CDs or another digital media player such as the Apple iPod or from terrestrial radio, satellite radio, Internet radio).

A business can have the right to play music from the radio under particular conditions that depend on the sizes of the establishment and the number of speakers used. Thus, in particular circumstances, it can be important for a user of the CLD to be able to ascertain if the music is coming from terrestrial or Internet radio. And as described above, satellite radio, which must be separately licensed, can also be identified as a sound source. Such identification can be challenging if the user is only hearing music from overhead speakers and just for a limited time.

Thus, various automated monitoring methods can be used to determine whether the copyrighted work played in an establishment was being broadcast over the radio.

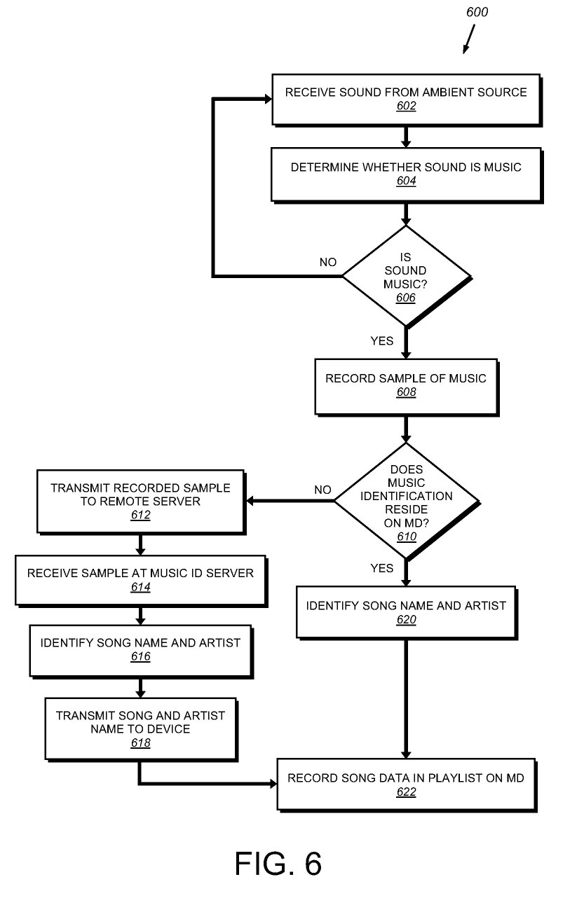

One automated method to determine if radio, either radio or satellite is playing at a venue would be to use the MIS to compile a playlist of songs, as will be described in greater detail below in reference to FIG. 6, played during the time the user was at the establishment. This compiled playlist can be compared to a database of playlists for each radio station on satellite and terrestrial radio. Companies such as Broadcast Data Systems maintain such playlists.

Another automated method of identifying a broadcast transmission can comprise analyzing the sound signal to look for repeating patterns of sound. If such sounds are relatively short (shorter than a song, for instance) it is likely that the sound artifact that was heard twice during one's stay at a particular business is a station ID, a lead-in to news or weather, a commercial, or other non-music content that is likely to be played repeatedly during the day. The fact that these sounds would not be identified as songs in the MIS would be further evidence the sounds were not music, and thus, likely originating from a radio broadcast, as the performance of a CD or mp3 file typically omits such unidentifiable segments.

In addition, the presence of signitifant quantities of unrecognized audio between recognized songs, of a length that is either substantially shorter than the average song, or significantly longer, would indicate that a radio was playing and that people were talking or ads were playing between songs.

In addition to fingerprinting type analysis, voice recognition can be used to get an understanding of any decipherable audio. Thus, news broadcasts, weather, and traffic audio content can be distinguished using speech-to-text technology with the meaning of the words employed to distinguish DJ or announcer talk from music that is characterized by spoken portions, such as rap.

Radio stations also often truncate or overdub songs at the beginning and end in a manner not usually accomplished when music is played via CDs or a digital playlist. This monitoring technique then would identify the song via the MIS and then compare the length of the song as played with the full length of the song. Combined with a lack of a pause between songs, such data can lead to a conclusion that the sound source was radio. If the monitoring application finds songs that are shorter than they ought to be, it will be an indication that the sound source is a radio.

Of course, a person can often detect if it is a radio playing or not. As such, human input can be part and parcel of this analysis. Automated detection, however, provides the solid evidence that a person's input might not.

The CLD can be accessible by a user or any member of the general public and can be searched to determine if a given business is stored in the CLD, and thus licensed to perform copyrighted works. The CLD can be accessible over the Internet, accessed via a computer 112, or a phone 106, for example. The CLD can also be accessible from a land line or ordinary cellular phone via a toll free hotline. This number can employ commercially available voice recognition technology. It can operate very similarly to the way a “411” (directory assistance) phone number directory operates, except it would list only those businesses that hold a license. In an illustrative embodiment, an audio menu can prompt the user to specify the city and state in which the business he is searching for is located. The user can then search by the name, address, or type of the business. As with the Internet accessible CLD, the user can search for an exact match or can listen to a list of businesses sorted, for example, alphabetically, by type, or by geographic location.

Additionally, in an illustrative embodiment, as the storage capacity of mobile devices increases the database can be downloaded and installed directly onto the user's device and thus the CLD can be accessible locally on the mobile device. According to the illustrative embodiment, the CLD can be set to automatically update itself at set periods using conventional client-server updater functions, either via cellular waves or wireless or wired Internet, in order that new additions to the CLD are continuously added to the onboard CLD.

Individuals are thus, enabled to report businesses that are playing unlicensed music or other content. Reporting can take place via an online form, that can be accessed from a ‘smart’ phone 106 or from a computer 112, or by a form created by telephoning a toll-free hotline equipped with voice recognition and voice to text capabilities. A user report can include details such as the name and location of a business, which can be determined by GPS data or by entering a specific business name or its address.

In an illustrative embodiment, a straightforward technique for determining the business in question is for a user to input the trade name of the business. The user can also provide other identifying data, such as the city and state or the entire address of the business premises in order to narrow the search down. Additionally, the CLD can allow the user to scroll through a list of all the establishments in a particular geographic area. The CLD can list businesses alphabetically by state, town, or by street as well as by type of business. The CLD can employ conventional closest-name matching techniques to list candidate names, and thereby speed the identification of a partially or incorrectly entered name.

The user report prepared based on the business name, as determined by GPS and/or user input, can also include data gathered by the user as evidence of an unlicensed performance. It can include the title of the material being displayed without a license, an audio recording of the performance, and video or photos of the business.

The Internet 111, upon receiving the title of the work and its copyright status, forwards this information, along with the business name and other data relating to the business, to a server application 122 via data stream 164. The server application 122, as will be described in greater detail below, determines the licensing status of the business and uses this information, along with the title of the work and business name, to prepare a user report, to be transmitted back to the Internet 111 via data stream 166, to thereby take appropriate enforcement actions upon discovering an unauthorized performance, as will also be described in greater detail hereinafter.

The server application 122 transmits the title of the copyrighted work and the business name to the CLD 124 via data stream 168. The CLD is searched to determine if the business is licensed to perform the copyrighted work. Upon receiving the licensing status of the business via data stream 170, the server application 122 determines if an unauthorized performance has occurred. If it determines that the business is performing one or more copyrighted works without a license, the associated business name is transmitted to a Database of Unlicensed Businesses (DUB) 126 via data stream 170. If the business is already listed in the DUB (i.e. the business has been reported before), this information is transmitted back to the server application via data stream 174 and included in the user report that is transmitted via data stream 166.

If the business is not already listed in the DUB, the business's information is stored in the DUB 126. This information can be published, as the DUB data can be transmitted to a DUB Publication process 128 via data stream 180, and then the published DUB can be transmitted to the Internet via data stream 182 so as to be viewed by any person desiring to search the CLD, or otherwise utilized according to an illustrative embodiment. The DUB can be maintained by the CLD system or the partnering licensing organizations and can be used to find and contact violators for enforcement action. Additionally, the DUB can be a separate storage structure or contained within the overall CLD data structure.

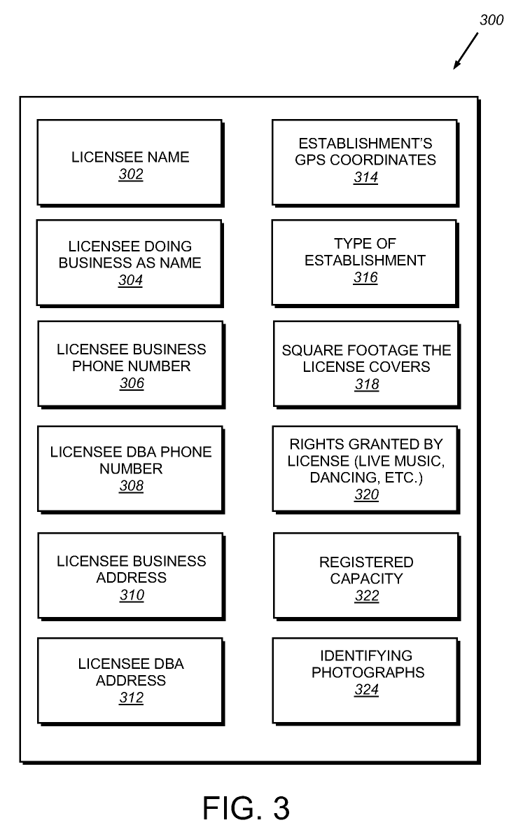

A user reporting the business to the DUB 128 supplies identifying information similar to that contained in the CLD 124, as will be described in greater detail below in reference to FIG. 3, to the extent he or she is able to gather such information. Other information, such as corporate offices or owners, can be obtained by the system or by the licensing organizations from public records.

All entries in the DUB 128 are checked against the entries in the CLD 124 to ensure that there are not properly licensed businesses incorrectly listed in the DUB.

The DUB 128 contains information on all reports that have been submitted regarding each listed business. Once a user submits a report to the DUB, the system can show a user, via a message on a dynamically configured webpage, phone call, email, SMS message or the like, information on whether the reported business has been reported before and any needed details on those reports. A user might not be granted compensation by the system (or receive reduced/modified compensation) if a predetermined number of reports have already been submitted.

Note that a user of the CLD system is not necessarily required to report an infringing business to the DUB. For instance, a user can determine that a business is in violation of its existing license but can decide to speak with the manager about the issue. Thus, the CLD can be designed in such a way that can indicate to the user that an infringing business has been located but not pass that information on to the respective licensing authorities at the request of the user. In an embodiment, the CLD can be adapted to delete any storage of such an incident in its own files.

Once it is determined that a business has been performing copyrighted material without the applicable license, the server application 122 transmits the results of the report through the Internet 111 so as to notify the business of such unauthorized use according to an illustrative embodiment. The business can be automatically contacted (by process 130), either by phone, mail, or both in the form of an enforcement notification via data stream 190. Once an unlicensed business has been reported to the DUB, the automatic enforcement notification mechanism according to an illustrative embodiment begins. This mechanism can involve an automatically generated phone message delivered to the premises of the unlicensed business. It can also involve an automatically generated mailing, email, or other communication to the premises or corporate offices of such premises.

An automatically delivered communication can notify the business that a violation had been reported. It can also outline the specific charges against the business, including date, time, and the specific copyrighted work involved. The message can also direct the business owner to a website or a phone number where he or she can apply for the proper license.

The infringement notification can also involve documentation of the specific violation. This can be a listing of the unlicensed works played and when they were played. It can also include a copy of a photograph or video that a user took in the business to clarify that the premise identification was accurate. The notification can also include application forms or other means to sign up for a license.

In order to prevent notifications from being incorrectly generated, a particular number of reports can have to be received for any given business. In the database every report can be recorded, however a notification might not be issued until a particular threshold number of reports had been received from different users.

Alternatively, at process block 132, the illustrative system can reward the user that reports the unlicensed business by sending notice of the reward via data stream 192, and/or at process block 134, the illustrative system can charge or bill the business for its unauthorized and/or unlicensed use of copyrighted works. An automatically generated notification informs business owners that they have been observed performing copyrighted material without a license, and outline the reported violation. The automatic notification can then offer a straightforward technique for the business owner to purchase a license.

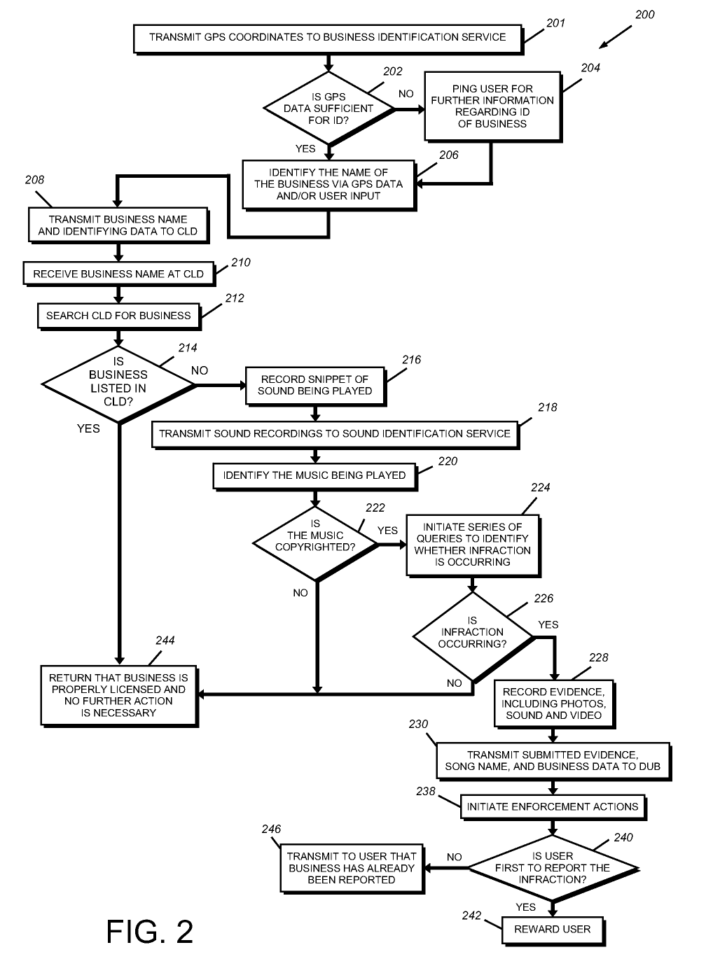

Referring now to FIG. 2, a flow chart of an illustrative procedure 200 for managing copyright licensing is provided. At step 201, the user transmits the GPS coordinates to a business identification service. The transmission of these coordinates can be based on physical input of data by the user from a separate source (e.g. a handheld GPS unit) or automatically using an embedded GPS in the connection device (e.g. cellular telephone). Note that the system can provide needed applications (employing conventional software algorithms) to the device to facilitate communication and/or transmission of the coordinates as needed. These GPS coordinates are used to determine the name of the business where the user is located. A variety of publically available services (Mapquest.com, Googlemaps, etc.) allow translation of coordinates to a business location where multiple locations are identified, a menu of possible locations can be provided to the user's device for selection of the proper location.

At step 202, the procedure 200 determines if the GPS data is sufficient to identify the business. If it is not, at step 204 the procedure 200 requests further information from the user to identify the business. This can include requiring the user to specify the business name, provide a photo, or present other information required to identify the business. At step 206, the procedure 200 identifies the business based on either the GPS data and/or the user input. The business name and any other relevant identifying data is transmitted to the CLD at step 208, which is received by the CLD at step 210.

At process step 212, the CLD is searched to determine if the business is in the CLD, by comparing the business name to a list contained in the CLD to determine if the business is on the list. If the business is listed in the CLD, the procedure 200 advances to step 244 as there is no further action required because the business is already licensed to perform the work.

However, if the business is not in the CLD, the procedure 200 continues to step 216 at which point a portion of the work is recorded. The recording of the copyrighted work is then transmitted to a work identification service at step 218 to identify the name of the copyrighted work. The particular work that is being analyzed is then identified at step 220.

With a full or partial recording from step 216, a user can report the playing of a particular copyrighted work, the title for which is not known. Identifying the sample is part of the process of assembling evidence of copyright infringement by the user in conjunction with the CLD system. By recording the act of copyright infringement and capturing metadata regarding time and place, the licensing organization obtains a complete record of a business's infringing act, including the song, time, date, and location.

In an illustrative embodiment, at step 216, the user can make a recording of a song using an appropriate device such as an MD. This recording can be of the song in its entirety or comprise just a brief portion of a song, for example a snippet of 30 seconds in length. The recording can be accomplished with the MD and can be saved on the MD and uploaded to a reporting form, either immediately from an MD or later on from a computer (112). If only a brief snippet were recorded, the snippet should be of sufficient length, and sufficient quality to enable identification of the song through a Music Identification Service (MIS) such as Shazam. After uploading the sound recording, the CLD recognizes the song and record the name and artist in the user submitted report. The MIS service provides a more reliable source for identifying the particular copyrighted work, as opposed to relying on the identification by the user.

An MIS-type system can also be applied to movies or television. Since every movie or program will have a unique audio track, an audio-derived database representing all movies and television shows can be constructed. Such an audio-derived database involves playing the audio from each piece of content and generating a “transformation” of such audio by putting the audio through a “transformation algorithm”. If another piece of audio were put through the same algorithm, it generates a “signature” that would match part of the transformation from the original piece of content. Similar “fingerprinting” techniques are used by services such as Shazam to identify specific songs.

In an illustrative embodiment, employing an MIS for video, users to upload to the video-derived database a brief recording of the audio from a movie, which can then be used to identify the movie and add it to the report. Alternatively, the user can report the assumed name of the movie or DVD and use the recording as evidence of the infringement in the event that a video-derived database is not available.

At process step 222, the licensing status of the work is ascertained, by determining if the particular work is copyrighted. If the work is not copyrighted, the procedure 200 advances to step 244 as there is no further action required.

Once it is established that a particular work is copyrighted, the process 200 determines whether an infringing act is occurring by initiating a series of queries to the user at process step 224. At step 226, the process determines if an infringing act has occurred. If an infringing act has not occurred, no further action is necessary and the process 200 advances to step 244.

If the process 200 determines at step 226 that an infringing act has occurred, it advances to step 228, at which point it obtains additional information or evidence pertaining to the infringing act. This information can include photos, sound recordings or videos of the infringing act, which become part of the user report.

On the report form the user can also have the option of uploading a picture or video of the unlicensed business at step 228. This picture or video can be taken with the MD. This visual provides additional evidence to identify the unlicensed business. The user can be prompted to take a photograph or video while the MD is recording sound, so that the sound snippet and photograph or video reflects the same moment in time, and have been taken at the same business.

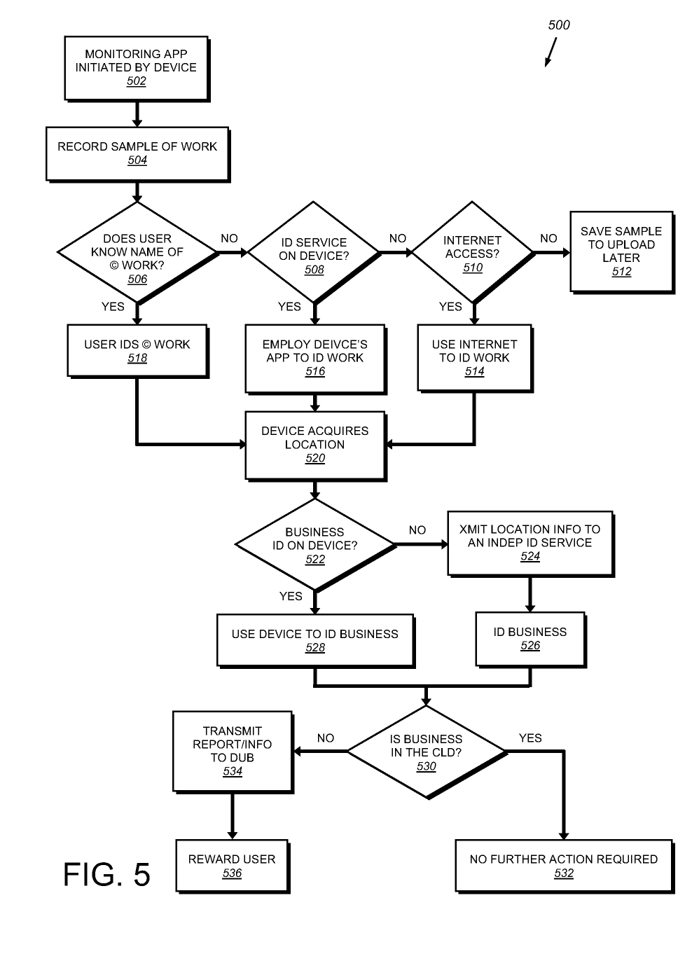

This evidence, along with the name of the copyrighted work and the business name, are transmitted to the DUB at step 230. The DUB stores this information to create a database that contains a listing of the unlicensed businesses. Once an unlicensed business has been reported to the DUB, an automatic enforcement notification mechanism 238 can ensue, as will be described in greater detail below in reference to FIG. 5.

In an illustrative embodiment, a user that is the first to report an unlicensed business can be rewarded for their efforts. Accordingly, at step 240, the procedure 200 determines if the user is the first to report the infringing act, by determining if the license was already listed in the DUB, or if it is added as a result of the infringing act. If this is the first user to report an infringing act, then at step 242 the process rewards the user. If this is not the first time that the business has been reported, then at step 246, the procedure transmits to the user that the business has already been reported.

Reference is now made to FIG. 3, showing an exemplary listing of data 300 that is stored with respect to a business within the CLD according to an illustrative embodiment. The CLD, in addition to containing information similar to that gathered and maintained by licensing authorities, also contains information needed for managing the copyright licensing according to an illustrative embodiment. Information in the CLD can therefore include a list of all licensed businesses (licensees), the type of license these businesses hold, and identifying information for those businesses. This identifying information includes the business's legal name 302, phone number 306, and address 3 10. The CLD can also include additional identifying information which is not currently gathered and which will allow customers at various businesses to more easily and correctly identify whether a particular business is or is not listed in the CLD. Such additional information might include the trade name of the business, or the name the licensee is doing business as (DBA) 304, the trade name phone number 308 and trade name address 312.

The CLD can also include GPS location data on the business 314. As stated above, this information can be supplied by the business or can be submitted by users of the CLD system. This data will serve to make the CLD a user-friendly system that will allow for easy identification of businesses. Such information allows users to identify establishments even if the listed business name and location are different then the DBA location and name.

A business listing in the CLD can also indicate the purported size of the establishment 318 as that metric can determine its right to play broadcast radio without a license. In general, the license arrangement currently provides that the size of a business determines the particular license that an establishment must obtain.

Accompanying a business's identifying information is a description of each license each business possesses 320. This description also describes in easy-to-understand language what copyrighted work a business has the right to play. For example, the CLD listing for a business licensed to play satellite radio can describe the mix of music that a customer can expect to hear or the frequency of station identification. A listing can also indicate whether the establishment has the right to play music over the phone when callers are on hold and whether the business is licensed to host live cover bands or DJs, and whether the license covers dancing. The listing can also include the registered capacity for the business 322, used in determining if it has infringed any licenses it has obtained.

The CLD can include an identifying photograph 324 to accompany each listing. This photograph can be of the sign or of the interior of the business so as to assist users in identifying the businesses, particularly in those cases where the registered name of the business differs from the “street” name, or where a parent company has obtained license rights for a number of different locations. Such a photograph can be added to the CLD as part of the application procedures by the management of an establishment. Additionally, photographs or other such identifying data can be added to business entries in the CLD by users. If users search the CLD and find a business, they can be offered the option to upload photographs or add other information which is helpful to other users in making a positive identification of the business. Alternatively, photos of the storefront, etc., can be obtained from commercial online web sites, which provide such information (e.g. Google).

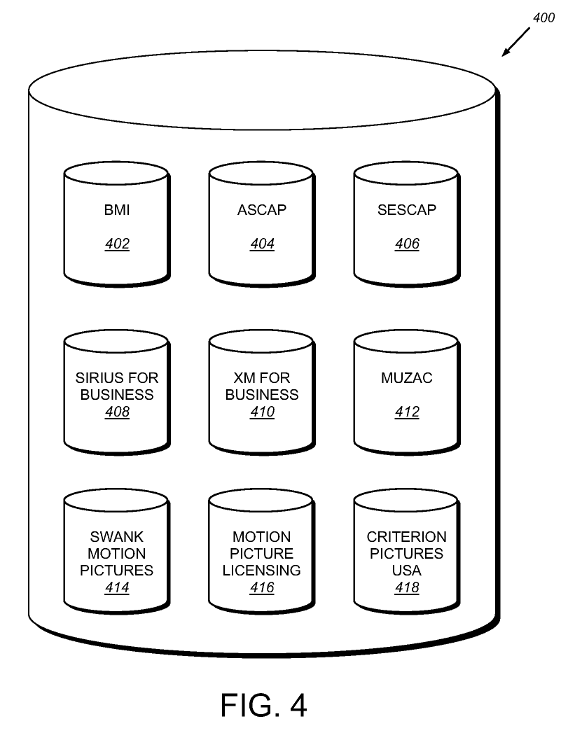

FIG. 4 is an exemplary CLD 400, showing data stored therein for a plurality of licensing authorities, and other sources of copyrighted works. For example, the database can contain information from BMI 402, ASCAP 404 and SESAC 406, the three main music-licensing groups in the US. Additionally, the CLD can contain information on businesses that have contracts with satellite radio, including, for example, commercial broadcasters such as Sirius 408 or XM radio 410 or Muzac 412, a music service. Businesses with such contracts are currently not required to obtain a direct license with a music licensing authority, as the licensing process is taken care of by the satellite provider. The CLD can also store information for movie licensing organizations, including Swank Motion Pictures 414, Motion Picture Licensing 416, and Criterion Pictures USA 418.

Including all possible licensing authorities in the CLD allows users to quickly and easily eliminate the possibility that a business is legally playing music under a license that is not listed in the database. The CLD in an illustrative embodiment, thus, resembles the database portrayed in FIG. 4, and contains all information in individual databases spanning music licensing services, satellite radio services, and movie licensing services, as well as any other relevant licensing authorities.

Reference is now made to FIG. 5, a flow chart detailing a procedure 500 for performing automated business licensing according to an illustrative embodiment. At process step 502, the device which a user is employing to monitor a business for unlicensed performances, initiates its monitoring application. An iPhone or other ‘smart’ MDs can be programmed to constantly monitor the music heard by a user throughout a day or other set period of time. This feature can allow a user to monitor businesses for copyright violations with little or no effort on the part of the user. It will allow all MDs to become monitors of unlicensed performances without requiring significant involvement by, or interaction with, the user.

The MD can be set to automatically record and recognize any music that it hears (process step 502). If a user is going out for the evening, he can select this feature and record everything he listens to in a restaurant or bar. Additionally, if the MD had GPS capability, it can be set to begin monitoring when the user carrying the MD enters a geographically defined area. If a user is at a business but has not activated the monitoring software, the device can sense through communication with a business identification service that it is at a business or in a commercial area and ping the user with the suggestion that automatic license monitoring be enabled.

Alternatively, the MDs GPS-enabled software can detect that the user was no longer traveling at a speed consistent with moving by car or other transit means. During those time periods when the GPS readings are relatively static, and the coordinates were for a location not frequented often (such as a house or classroom) the software assumes the user was in a premise of some sort and start to listen for music. (Such an algorithm would eliminate the needless monitoring of in-car radio, for instance.) If monitoring at that location had been done before and resulted in a clean copyright bill of health for the establishment, such listening might not commence.

At process step 504, the recording mechanism is triggered to start recording the copyrighted work. This may be accomplished by employing, for example, a tilt-sensor in the MD. This sensor would be able to sense if the device was lying flat, as if the user took it out and placed it on the table. Thus, the MD would not record if it was not lying flat. The MD would thus not try to record from a pocket or a bag, where the recordings potentially would not be of a high quality.

The MD can alternatively employ MIS-like software to determine when to begin recording. The software monitors sounds for some period of time before beginning to record. The monitoring can determine whether the sounds are music or conversation mixed with music before the MD records any sound. If desired, this software can ensure that the device only records music, and not conversations, thereby avoiding any potential privacy concerns.

Once music is detected, recording can commence and continue without pause until music was no longer detected. Alternatively, monitoring and recording activities can be intermittent and occur at preset or random intervals. Each recording preferably contains a timestamp stating the date and time the recording was made.

The process then determines the specific copyrighted work that is being performed. At process step 506, the user is queried to determine if they can identify the copyrighted work. If they cannot, it is determined at process step 508 whether there is an identification service contained on the device. If there is an identification service on the device, this is employed to identify the copyrighted work. If there is no identification service, the process determines if the device has Internet access at step 510.

If there is no Internet access available on the device, the data is stored in the device, so as to be uploaded at a later time at process step 512. Since all data can be saved on a device and uploaded via the Internet at a later time, the MD used does not have to have wireless or cellular capabilities. An iPod (114), for example, can be used to record and store data until transmission takes place through a different device at a later time.

Alternatively, if the device does have an identification service, this is employed at process step 516 to identify the particular copyrighted work. If the user knows the particular copyrighted work that is being performed, the user identifies the copyrighted work at process step 518.

The device acquires information about the location of the user (for example GPS coordinates) at process step 520. The location information is used to determine the particular business, or other establishment, at which the user is located. At step 522 the process determines if there is a business identification service contained on the device. If there is no such application on the device, the information is transmitted to an independent identification service at step 524, which identifies the business name at process step 526. If the device contains a business identification application, that is used at step 528 to identify the business.

The MD can have GPS capabilities that enable the device to record the location of every recorded snippet. This GPS data can be matched to a database of geo-coded addresses, and more particularly a list of businesses so that the name of the business can then be identified. The GPS function can also be used to determine whether a user is at a business or in a private area where licensing is not an issue. GPS data can also be used to determine that a user was at a house or other residence rather than a business.

If the analysis of infringement was done locally, that is, determined by the MD, the MD might alert the user (via a vibration or ring with attendant on-screen or audio message) that an infringement had been found. Such live notification would allow the user to take other action, such as collecting more information (perhaps filming a short segment of video while being inside the premises) regarding infringement.

Once the songs played have been identified, the titles are transmitted to the CLD to determine if the business is in the CLD at process step 530. Also transmitted will be data on where and when the music was recorded and identifying metadata on the user. Location data can be cross-referenced against all of the businesses entered into the CLD. If the business is listed in the CLD, the process advances to step 532, as no further action is required because there is no infringing act. If the location is not in the CLD, then an automatic infringing act report will be generated and transmitted to the DUB at process step 534. The CLD can alternatively contact the user if an infringing act is found but before the infringing business is reported to the CLD. The user will then be able to decide whether or not to report the business to CLD.

The user reporting the unauthorized performance can then be rewarded at process step 536. Compensation for users participating in the program of automatic business license monitoring can be similar to the compensation scheme for participation in the CLD. In addition to being rewarded when a business is caught operating without a license, however, participants can be granted some small compensation merely for agreeing to participate in the monitoring scheme, and thus more users will be attracted to the program.

FIG. 6 is a flow chart of a procedure 600 for ambient playlist generation according to an illustrative embodiment. This playlist generation procedure 600 is one method for determining if a business is playing a radio (as opposed to a broadcast of licensed music). Some businesses may have the right to play music from the radio under certain conditions that depend on the size of an establishment and the number of speakers from which the music is played. Thus, in particular circumstances, it is desirable for a user of the CLD to be able to ascertain the source of the music.

At process step 602, a sound is received from the ambient source to determine if the sound is music at step 604. Process decision step 606 determines if the sound is music or not. Music monitoring would involve sampling the audio environment on a periodic basis, listening for music, (with or without conversation or other noises in the background) and then recording a sample of any songs heard at step 608. The MD can interact with an MIS to indentify from which songs such snippets were recorded. The results would comprise an “Ambient Playlist” (the AP), that is a list of songs that the user had been exposed to during that time period.

Songs on the AP can also be geo-coded by the location of where the snippet was recorded if the MD was GPS-enabled. A MD with a GPS device in it can access a database assigning addresses and business names to GPS locations, such as a geo-coded yellow pages directory. Such a database would allow the MD to assign a business name to a location. Subsequently, a user can access the name and other identifying data of a song that was played in a specific location. For example, a user might remember the name of the store where a favorite song was playing in the background but not the name of the song. The user can access a list of all the songs played in that specific store, and then readily determine the name of the song.

The AP can also contain a link to a music vendor, such as Apple's iTunes store, or another, similar vehicle by which each song can by purchased online. In this way, the user can easily purchase songs that were included in the AP. The user would thus have access to a list of all the music heard over a period of time, as well as a straightforward mechanism to acquire the music.

The AP can also be linked to the user's music catalog, that is the user's library of owned music and perhaps even a database expressing how often specific songs or song-types were listened to or heard by the user. Such a link would allow the user to sort the AP in a way such that songs most likely to be appreciated would be apparent. For example, if a user had previously listened to a substantial quantity of recordings of rap music, or had purchased rap music through the MD, then the software would sort rap songs to the top of the AP. This would serve to separate the songs a user is likely to be interested in from those which will not interest the user. If a user had encountered 100 songs in a day, this simplifies the process of sorting through them and finding the two or three he or she prefers and is interested in hearing again.

A given user can be exposed to the same song multiple times. The AP can note such repeat exposures and use this frequency measure as another means by which to sort the list. Such a sorting means would be useful for spotting new songs that the user had “not heard” before (at least from the perspective of the MD). The AP might check the user's library of owned music before declaring that the user may not have heard the song before because the user might already own it. The system can also compare additions to the AP against the user's library of owned music. If a song was already listed in the library, the AP can make note of that. With metadata established from this crosscheck, the user would be able to identify songs that had not been purchased yet and can sort the AP by this metric as well.

In addition to just recording snippets, the MD can also use its music monitoring capability to actually record the entire song for future playback and enjoyment. Such analog recordings are legally permissible under the Audio Home Recording Act. With the goal of recording listenable music, the music monitoring function can sample the environment more frequently in order to capture more songs. The default setting can be on record, with recording only ceasing when it is clear that there is no recordable music in the background, or only music from a genre not preferred by the user, or when turned off by the user. Such recording might only occur if the quality was deemed to meet a particular threshold. If the quality was suspect, the user can be notified while the recording was in process, or the device can be programmed to automatically record only when a particular preset quality level was met. This level can be specified by the user and those with different standards would thus be able to personalize use of the device.

With this feature users can record and store music recordings which can be played later on the MD or uploaded to another device such as a computer to be played. The recorded music would be identified by an MIS and stored under its title and artist. As the quality of recordings improves, this will become a more attractive option than it is currently. In the future, recording software may also have the ability to filter out background and extraneous noises, leaving a very listenable recording of the music.

The system would be able to parse a multi-song recording into discrete tracks by noting where in the song the “fingerprint” used by the MIS is located. Knowing the nominal length of the song, and this fingerprint location, the beginning and end of the song can be deduced. By way of further background, such fingerprint technology is described by Logan U.S. Pat. No. 6,088,455, issued Jul. 11, 2000, the teachings of which are expressly incorporated herein by reference.

As discussed with respect to the AP, such a list of recordings can be filtered according to which songs the user already owned, by frequency of capture, location, and other metrics. Better quality recordings can be brought to the user's attention, as well.

If song-recognition is accomplished in (nearly) real-time, such recognition information can be used to determine if the recording should continue. Thus, the MD might note that a song it started to record was already in its list of recordings, or already owned by the user, or of a type not generally preferred by the owner, in which case, it ceases to record the song.

If the sound is not identified as music, the procedure returns to step 602 to receive sound from the ambient source. If the sound is music, the procedure advances to step 608 at which point a sample (i.e. recording) of the music is obtained. This is used to determine which particular song is being played, and then added to a playlist on the MD.

The CLD system can aggregate ambient playlists across a number of, or all users of the system. Such users may have already consented to the use of their ambient playlist information for this purpose. Such aggregation offers useful information to the creators of the ambient playlists, venue owners, and licensing bodies. To achieve maximum value from such use, entries in the playlist would need to be tagged with the type of location in which the content was heard. Thus, songs on an ambient playlist that were heard on a college campus might be distinguished from those heard in restaurants.

Licensing bodies might use such aggregated information as an unbiased estimate of public performance frequency of the songs it licenses. Such information might then be used to allocate licensing fees back to artists. Such estimates, however, would require that only songs that were played in public venues were considered when aggregating the data.

Venue owners can also be interested in such information, as it would provide a vehicle by which to compare the music performed in their locations with that performed in other similar venues. Such comparisons can require that the venue create its own playlist and that the database of playlists be able to be sorted by venue type. According to an embodiment, businesses can be required to pay a further license fee for such information.

Users can also make use of aggregated playlist information by comparing their lists to those generated by friends, the public at large, or subsets of the public.

Data obtained by aggregating ambient playlists can represent a biased sample of all such music played in public venues, as there can be a particular bias regarding who wishes to create such playlists and further share them. Therefore, it would be desirable to try to understand such biases and adjust for them in the analysis of such aggregated data.

At step 610, the process determines whether the MD has a music identification service residing thereon. If there is a music identification service, it is employed by the process at step 611. If no music ID service is present on the MD, the process advances to step 612, at which point the recorded sample is transmitted to the remote server application 122. At process step 614, the music identification service receives the sample and employs its music identification software to determine the content (i.e. song, etc.) contained in the sample. This is then transmitted to the MD at step 618.

If Music identification software does reside on the MD, and this software is employed, then the process employs step 620 and the song name and artist is identified by the MD. The process employs step 622 to store the name as data in the form of a playlist on the MD. In this manner, a playlist of the songs and/or other copyrighted works performed at an establishment can be compiled for any number of uses, including but not limited to billing a business and general playlist generation.

Note that the teachings of FIG. 6 are described in the context of a song and artist name. However this description is applicable to any work that may be copyrightable, including movies, pictures, art, and television broadcasts, among others.

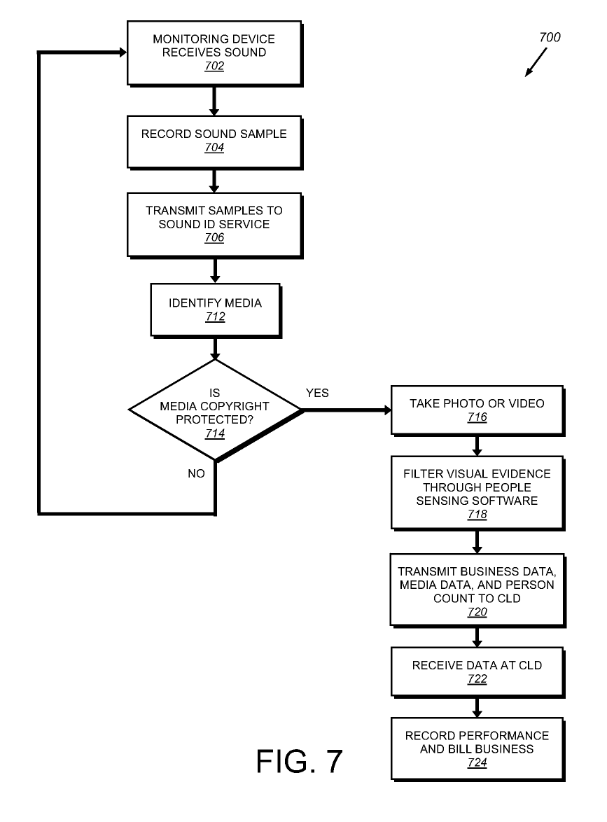

Reference is now made to FIG. 7, a flow chart of an illustrative procedure 700 for licensing copyrighted work in an ex post media manner. Currently, in order to license a public showing of a movie a business or organization is required to contact the licensing company in advance. A license is granted for a specific movie for a specific date, time, and location. A business owner cannot simply decide to show a movie at any given time. Rather, he or she must plan as much as several days ahead in order to arrange and pay for the requisite motion picture license. The complexity and preplanning required results in fewer showings of movies than would occur with a more automated and straightforward system.

In addition, the custom in the movie industry is to pay studios per person when they license out rights for their movies to be shown in public. Theatres are best equipped to handle this chore of counting and controlling the crowds that enter their theatres. This invention facilitates a new copyright regime and offers a new technology that supported the idea that venues can offer intermittent movie fare and do it in a more casual fashion. That is, tickets, per se, might not need to be sold and there would be no need for an entranceway through which one must pass to observe the performance of a movie. Thus, a hotel bar might set up a large screen on Saturday nights and show a popular movie. Guests can come and go as they pleased. Drinks and food served would generate enough revenue to support the licensing fee. In this manner, a bar or restaurant can be turned into a mini movie theater. Such a result would depend on the monitoring techniques described below.

In the context of music, business owners must buy a blanket, annual license. If a business owner only plays music occasionally, then the annual license will likely be prohibitively expensive and not worth the cost. Providing a method of licensing music on a per-play basis (after the song has been played, according to an ex post media licensing process) increases the number of businesses who would be interested in purchasing a license. This method allows businesses to control and monitor costs more effectively by transforming a fixed cost into a cost that varies based upon the amount of music played.

Employing an appropriate monitoring system, copyright holders are more apt to license their works for public performance on a per-use basis, as this system assures copyright holders of accurate knowledge of the particular work that has been performed. Furthermore, movie rights holders in particular are thereby more inclined to license such works if it can be done on a per-head basis, provided they had good estimates of how many people consumed such content. With such technology and licensing structure, businesses would be able to play as many movies or songs as they wanted, whenever they wanted, ideally paying for such rights after-the-fact, according to an ex post media licensing process.

A licensing regime relies on monitoring technology either built into a device such as the iPhone available from Apple, or a similarly functional device, or built into a stand alone device connected to the Internet and used solely for this monitoring function. Either type of monitoring device can monitor the sounds heard in the business to receive a sound at step 702 according to the illustrative process and then record a sample at step 704. The monitoring device matches the sounds recorded to a sound identification service by first transmitting the sample at step 706 that identifies the media that the business is performing at step 712.

The monitoring device can also include GPS capabilities directly thereon. The GPS capability enables the licensing organization to ensure that the monitoring device is in the particular location that it presumes to be and monitoring all media performed in the business. In this manner, business owners cannot play media in the business without the monitoring device being present, as it prevents performance unless the device is present.

Licensing agencies can track the playing of content at various venues if performances employ controlled playback devices that report performance information back to the licensing organization (as some online jukeboxes do). However, the monitor-and-match technology described herein allows the venue to use any sound or video source they choose for their public performance, while still assuring the licensing body that they are being fairly compensated.

Businesses can be licensed under this regime and obtain a required monitor to allow businesses to pay for the movies or the music that they have performed in their establishment after the fact. The system can produce an invoice reflecting the content performed and automatically send the invoice at a particular date and/or time. The amount charged per film or per song can be a function of the content, but also size of the business, the day of the week and the time of day, as well as the number of people counted by the monitoring device.

In an illustrative embodiment, the monitoring device can be programmed to turn on at step 702 and record a sound sample at step 704. This can be accomplished randomly, or at prearranged intervals, in a manner similar to that by which the software for Ambient Playlist generation described above works. For example, if it was programmed to record every 5 minutes, it can identify any television show or movie that was played based on the recording. Recording intermittently reduces privacy problems by recording only a small sample of the work. Additionally, such concerns can be further reduced by converting the sound samples to “fingerprints” (or signatures) that can be compared to a sound identification database to determine if the recorded sample matches any entries in the sound identification database to thereby identify the source of the sound at process step 712.

The SID may be stored on the device or the device can transmit the recorded snippets (or samples) to a remote SID via the Internet(wireless or Ethernet), or by cellular transmissions or any other appropriate communication process. Any copyrighted movies or songs played in a business can be identified by the sound identification database, as outlined above. Identifying the media content in this manner allows the system to determine whether the business is charged for the performance and which licensing authority to which the business owes the licensing fee.

The monitoring device can also include a visual component that can take a photograph or video at process step 716, which would then be filtered through “headcount sensing” software at process step 718. This software can determine which of the shapes in the video (or photograph) are people, and then provide an estimate of the number of customers present that are watching the video or listening to music. This headcount sensing can be accomplished by employing infrared heat sensors, or like optical shape-recognition technologies. This headcount number can be included in the record of when and what media is performed, and also included in determining the price charged by the licensing organization for the performance of a copyrighted work.

The headcount information can be used to determine the licensing fee for playing music under a headcount-based licensing regime to license media employing a per-play plan. Thus, different prices can be charged for different songs and for different times of day. In addition, the number of people listening, as determined from the headcount monitoring system, is a factor in determining the price of the license.

The data from the headcount monitoring system can be generated often or even continuously and be averaged over time. Thus if a movie studio desires to charge for showing a movie on a per-person basis, they can base such charge on the average headcount detected while the movie plays. In an alternate embodiment, the software discerns the different people that had seen all or part of the movie. The charge by the studio can include charges for partial views by each individual viewer, employing this headcount monitoring system.

Face recognition software can also be used (assuming the light level was adequate) to determine how many different people spent some time watching the movie or part of it. Alternatively, other algorithms using data collected from any angle can study the movement of people in and out of the room to estimate how many people were present for all or part of a movie, or listened to all or part of a song.

Once the device identifies the content being performed at a business, the device transmits the name of the media content, time of performance, the business's name and other identifying data to the CLD at process step 720. The CLD can be managed by the licensing organizations and tracks the particular copyrighted works that are performed and the fees owed by each business to the respective licensing organization. This information is received and processed by the CLD at step 722. The CLD records the time of the performance and the media type, by name, that was performed, to generate an invoice of the licensing fees owed for those performances at process step 724.

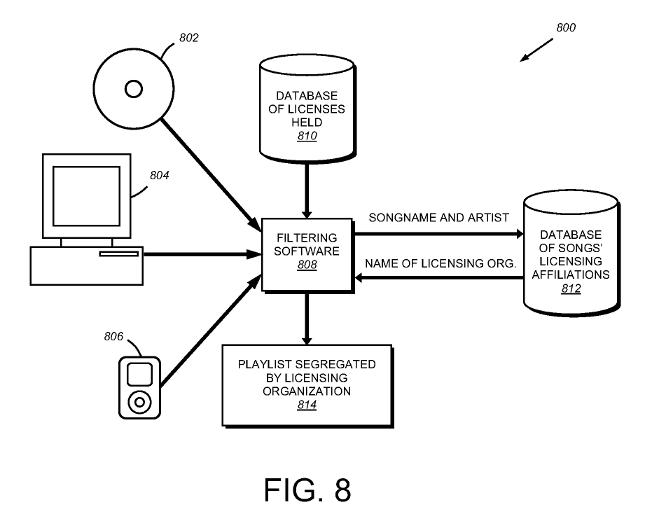

Reference is now made to FIG. 8, a block diagram showing the overall process architecture for a system 800 that employs software to allow for filtering of the copyrighted works by its associated licensing agency. A business owner desiring to purchase a business license should purchase a license from each of the three performance rights organizations in order to avoid inadvertently playing a song that was not covered by a license. If owners were to purchase licenses from only one of the licensees, they would need to ensure that they are entitled to play a song, based on each licensing organization's repertoire. Additionally, business owner can inadvertently playing music, perhaps by a local band, which is not covered by any of the licensing organizations.

The CLD improves this process for business owners by allowing business owners to automatically retrieve the performance rights organization affiliated with any song they desire to play and to sort their music selections accordingly, if so desired. Songs can, for example, then be automatically sorted into a playlist containing only songs which the business has a license to play. In this manner, businesses can ensure that they do not accidentally perform media which they do not have the right to play and inadvertently infringe on a copyright. This also provides a playlist of authorized copyrighted works.

Copyrighted works performed in a business may originate from several sources. The work may originate from a recording, such as a CD (802), from a digital file on a computer (804), or from a portable music device, such as an iPod available from Apple (806). The copyrighted work is transmitted to filtering software 808 to determine the associated licensing organization. The filtering software is operatively connected to a database 810 listing the songs to which the business has licensed by virtue of its licenses with the various licensing bodies.

The name and/or artist of each song that the venue desires to perform or otherwise play is then transmitted to the filtering software and compared to the database of allowed songs 812. The comparison will determine the performance rights organization affiliated with each song, or that no performance rights organization is affiliated with a song if that is the case (812). The system can be mandated so that this comparison is done for every song on a playlist that has been placed on a business's sound system.

The filtering software will then sort the music into a playlist 814 based upon the licensing organization associated with each song and the licenses held by the business. The sorting of the playlist can also remove any songs from the playlist which a business is not authorized to play Alternatively, the songs can remain on the playlist but are automatically omitted from the rotation so as to avoid performing an infringing act. Employing this filtering software, a DJ is able to maintain a playlist which can be useful at a later date, while still preventing songs for which the business did not have a license from being performed.

The database of allowed and licensed songs 812 may reside within the sound system in the business. Alternatively, the database can be at a remote location. For example, the database can be maintained by the CLD thereby ensuring that all entries in the database are current and accurate. The filtering software can regularly communicate with the database of licenses held via the Internet, and thus have a current and accurate list of all of the song licenses that a business has obtained, thereby removing incorrect songs through filters.

The filtering system further allows business owners to determine whether it would be worthwhile to purchase additional licenses. The software can keep track of the number of times the business attempted to play songs from a performance rights organization to which the business did not subscribe. These statistics provide a business owner with information to determine whether it is desirable to purchase additional license(s). The system can also employ a mechanism for readily purchasing additional licenses from other performance rights organizations. If a business attempts to play several songs from a particular organization, the software can determine if the user desires to acquire that license.

Additionally, the system can also indicate whether an existing license with a licensing body is being adequately used and if not, the system can suggest that such license be terminated.

This filter can also be used to prevent music for which a business did not have a license from being initially loaded onto that business's sound system. For example, if an employee in a business were to attempt to download a song from iTunes for which the business did not have a license, the filtering software can either not allow the download, or first issue a warning that the business did not have a public performance license for that song.

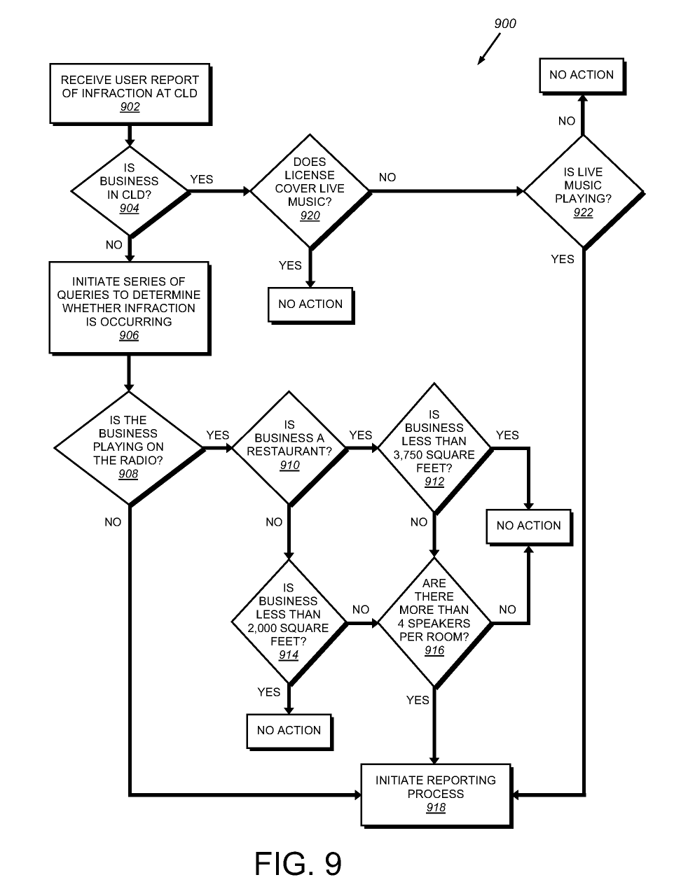

Reference is now made to FIG. 9, a flow chart detailing a procedure 900 employing the process steps to properly perform a reporting process according to an illustrative embodiment of the invention. This process involves verifying that an infringing act is occurring by obtaining additional user input. The process begins at step 902 there the CLD receives a user report of infringing action and then at step 904 the process determines if the business is in the CLD. If the business is not in the CLD, further analysis can be employed at step 906 to determine if there was copyright infringement occurring as a result of the public performance of a particular copyrighted work. To perform such analysis, the CLD can utilize a query system that asks the user a series of questions pertaining to the establishment and the music being played. This allows the CLD to gather information to determine whether or not an infringing act had occurred. These questions can be in an Internet form, SMS messages, email, or over the phone.

The particular result of each of these questions determine whether the performance was in fact an infringement due to lack of a license or an infringement of the terms of a license, or whether there was no infringement at all. Such questions would address whether the music came from a radio at process step 908. If the music is not from a radio, there is no further action and the reporting process is initiated to report the violation to the particular business. Under particular circumstances, a business may be authorized to play radio, and thus the process initiates a further series of questions to determine if it is an authorized transmission of the radio. At process step 910, the type of business is identified, as being a restaurant or not. If it is not a restaurant, and at step 914 the process determines that the business is less than 2,000 square feet, then there is no action, as the performance is authorized. If the business is not less than 2,000 square feet, the number of speakers per room is determined at process step 916. If there are more than 4 speakers per room, the process employs step 918 to initiate the reporting process. If there are not more than 4 speakers per room, then no action is required as this is a permitted radio transmission.

If the business is a restaurant, the process determines at step 912 whether the business is less than 3,750 square feet. If it is less than 3,750 square feet, then no action is required as it is within the allowed size for radio transmissions. If the business is not less than 3,750 square feet, the process employs step 916, as described above, to determine the number of speakers in the room, and thus, whether the business has committed an infringing act.

Based upon the responses input by the user, the system will automatically return the response that either no infringement is occurring or continue to submit queries to the user.

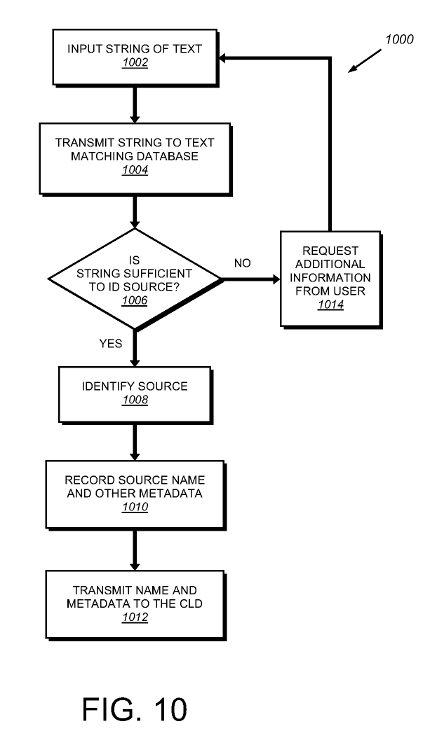

FIG. 10 is a flow diagram showing the lyric and text dialogue matching procedure 1000 according to an illustrative embodiment. The CLD can also employ a text-lyric matching process in such a manner that a user can identify a song without knowing the name of the song or the performer, particularly where a recording on the song is not available. According to an illustrative embodiment, users indicating on the reporting form that they did not know the title of the song played are prompted to enter a string of words or lyrics from the song at process step 1002. A separate database would catalogue song lyrics and their titles at process step 1004. Based upon the inputted lyrics, the database would identify the title of the song, and then proceed to continue its analysis.

This “lyric matching” system can also be applied to television shows or movies as a “dialogue matcher”. In this form, the user would enter a short string of dialogue from a show or movie that the user can not identify. In addition to dialogue, the user can enter the names of one or more actors or actresses in the TV show or movie as a means of identification. A database would match that string and the actor if necessary with the title, and transmit a report listing the information as outlined above. For TV shows, the identity of the precise episode may not be necessary for the system if identifying the series alone sufficed.

It is likely that a string of lyrics may show up in more than one song and that likewise a string of dialogue will show up in multiple movies or TV shows. Accordingly, the database that identifies a song or movie based upon user inputted text can prompt the user for more information such as additional string of lyrics or dialogue at process step 1014. Alternatively, the CLD can present possible additional lyrics from a song or dialogue from a video it suspects may be the one in question to see if the user recognizes them. The database can also return a list of songs containing the string of lyrics, or shows with the dialogue, and allow the user to select which of the songs is playing. Even if users were not sure of a song title or artist, they might be able to select the correct title and artist from a list of possibilities.

The text matching database identifies the source of the copyrighted work at process step 1008. This information is recorded at process step 1010 and then transmitted to the CLD at process step 1012.

The various alternate embodiments of the present invention described herein provide users with a process for determining the licensing status of a business and/or the copyrighted work that is being performed. In accordance with the present invention there are several considerations useful in implementing the processes herein. These include the following.

Other Considerations

Publication of the DUB

A publicly available database of unlicensed businesses (i.e. businesses that have been reported using copyrighted content without a license or the proper license) may also be provided. In an illustrative embodiment, a business guilty of unlicensed performances could receive a report of the infringing act and that business can be entered into a published version of the DUB. The published DUB can be available online and can be accessed and searched by business owners, managers, customers or other interested parties. Users can search for a business utilizing any of a number of factors, including by address or type of business. A further advantage of the DUB is the chilling effect it can have for patrons of the business-which may now be perceived as an unfair competitor with respect to other similarly situated (and license-paying) to other businesses as a result of its illegal copyright theft.

Accompanying the database of unlicensed businesses can likely be a publicity campaign, advertising the database in addition to the problem of unlicensed public performances. The advertisement can also include stickers or posters to be displayed in the windows or elsewhere in a correctly licensed business. The stickers can state the licensing status of a business, by stating “Proudly licensed by ASCAP”, or the like. The effect of this campaign is to draw further attention to and disdain for businesses operating without proper copyright licenses. This encourages customers to assist in copyright enforcement efforts and to encourage infringing businesses to purchase a license rather than risk losing business.

Process for a Attracting and Compensating Volunteer “Monitors”

This invention relies on the ability of a number of people to contribute their efforts to monitor copyright infringement. Participation in a monitoring program appeals to people including music writers, members of bands and other musical groups, as well as people who make their living in other creative professions, many of whom are harmed by the unlicensed usage of copyrighted content. It is possible, however, that large numbers of people will not be interested in participating in a program such as that laid forth in this description merely to help enforce copyrights. Thus, in order to encourage a large number of people to participate, it may be necessary to offer some form of compensation in exchange for participation in the monitoring of public establishments.

Compensation can be offered for submitting a record of media content being played a business or public area not listed in the CLD. Compensation may also be offered specifically for a volunteer monitor that discovers an establishment is performing copyrighted content without a license.

Compensation can be in the form of small cash payment, or some form of gift certificate. One form of merchandise compensation that would be appreciated by music fans would be free credits at the iTunes store. Another system can offer points to be accumulated and exchanged for different levels of rewards. Public recognition could be offered via inclusion in a voluntary registry of individuals doing the most to foster honesty in the public performance of copyrighted material.

To the extent that the earning of compensation required the user to record some or all of a sound recording, the licensing bodies can agree in their Terms of Service or other similar material, that users have such a right to record the music if the recordings were to fall outside of the Audio Recording Act or in other ways be deemed to be a copyright infringement.

Monitoring On-Hold Music

Businesses that desire to use copyrighted musical works over their phone systems, such as when music is played while a customer that has called the business is “on-hold”, must obtain the relevant copyright license. The CLD can therefore be expanded to include monitoring of music or other media that is played while a telephone caller is placed on-hold.

The CLD can thus further include the names of businesses which have a license to play on-hold music. The database can also contain other identifying information, including the phone numbers that play the on-hold music. Users can search the CLD based upon the name of the business they had called, or by the phone number dialed. When users encounter on-hold music, they can verify the licensing status of the business by searching the CLD.

Reporting of businesses playing on-hold music can be accomplished by the same methods used to report in-premise performance infringements at a business location. Once users have verified that the business in question is not listed in the CLD and does not hold the appropriate license, they will be able to submit the name, phone number, and other contact and identifying data of the business. This data can be submitted via a phone call, SMS message, email, or online form. Users may also be able to upload a recording of the on-hold music being played. Once users have generated a particular threshold number of reports on an individual business, that business will be listed in the DUB and enforcement actions will be initiated against the business.

On-hold music monitoring can also be performed automatically. This embodiment can utilize a Smartphone, which can be a cellular phone such as an iPhone or Blackberry. The Smartphone can also be a landline, in which case it would likely be a computer-based voice over Internet protocol system. In the automatic method, Smartphones would have software which would recognize when music, rather than conversation, was being received by the Smartphone. If music is detected for a set period of time, then a Smartphone will automatically search the CLD for the phone number which was dialed. If the phone number is found to be listed, then the business is appropriately licensed and no further action is required.

If the phone number is not listed, then the Smartphone will automatically generate a report and transmit to the CLD the phone number called, the date and time, and possibly a recording of the music being played. The name of the business can then be discovered by searching an online Yellow Pages listing or information service. Alternatively, the CLD can contact the user, via SMS message, phone call, or email, and request further information on the business that had been called.

Monitoring of music-on-hold infringement can be performed, as well, via call center operators or automated calling machines. As businesses are not protected by the Do-Not-Call law, business numbers not in the licensed database can be called at random, preferably at the busiest part of their day in order to increase the chance of being put on hold, in order to ascertain if they are playing music on hold. If operators were used, they can ask questions in such a manner to be placed on hold on purpose.

Recordings of the content being played on-hold can be used to determine that the content is copyright protected and requires a license to play. The recording can be transmitted to a music identification service which would return the name of the song being played. This name would then be transmitted to a database of the licensing organizations repertoires in order to ensure that the song is in fact protected and requires a license to use.

The reporting process would be substantially simpler than with in-store monitoring. A business must have a license in order to play on-hold music regardless of whether the media being played is radio or not. Thus, a user must only discover that a business uses copyrighted music for its on-hold music and does not have an on-hold music license in order to determine that a copyright infringement is occurring.

The results from such a data exchange, regardless of how it was done, can be made publically available. The public can then peruse the results, as described below, in order to verify that the venue was reporting accurate results.

Public Monitoring of the Automated Monitoring System

Under a per-play and per-person licensing process, public participation can be used to ensure the integrity of the results. Making details of each licensing arrangement publicly viewable allows for such public monitoring. For instance, interested or concerned customers at a given venue, can use their MDs to go online and see if a given establishment was listed in the CLD as described above. Furthermore, the user can confirm that the songs or movies that are being performed at a particular time are the ones that are being reported back to the licensing body and/or the CLD system. Such confirmation can be done via the user's knowledge of the material or by use of music and dialog identification software. Evidence collection, reporting and reward systems can be similar to those described above.

The number of individual viewers or listeners counted can also be made publically available online. This count can also be displayed somewhere in the business in an area and format which would be easily accessible and readable by the customers without going online. This count can then be verified or refuted by customers, in order to ensure that the sensing device was making an accurate count and that the counting device can not be tampered with by the business owner. If the number was viewed to be incorrect, then customers can report their own count, potentially via the same reporting methods utilized by the CLD, allowing for reporting over the Internet, phone line, or cell phone and supplying time-stamped video or photographic evidence to support their contention.

Headcount Monitoring of Movie Theatres

The per-head monitoring technology described above can also be employed in theatres where such establishments already have licenses to show content. Such licenses, however, require payment on a per-head basis the accounting for which is done via the tracking of ticket sales. Occasionally, such ticket sales fail to get reported to the proper licensing body. In addition, license holders are short-changed when typically younger patrons move from to a second screen after the first movie is over, without buying a second ticket. Such screen hopping deprives the copyright holder of some of their rightful compensation.

License holders can thus insist, as part of their licensing policy or in individual cases, that theatres install monitoring devices using either infrared or optical sensing means and related headcount or facial recognition software as described above. Such monitoring devices can be connected to the Internet and even controlled by the licensing agency. Data provided by such devices can be compared to reported ticket sales to determine if the copyright holder is owed additional compensation. Such data may also be available to the public at large in order to ensure that the theater owner is not deceiving the device in some manner.

The foregoing has been a detailed description of illustrative embodiments of the invention. Various modifications and additions can be made without departing from the spirit and scope of this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. For example, the illustrative processes herein have been described largely in the context of music being played at a restaurant or bar. Accordingly, this description is meant to be taken only by way of example, and not to otherwise limit the scope of this invention.

What is claimed is:

1. A system for managing copyright licensing comprising:
a device for recording a sample of a copyrighted work and obtaining business location information for at least one business performing the copyrighted work;
a business location identification process for determining the name and location of the at least one business based on the business location information provided by the device;
a copyrighted work identification process for identifying the title of the copyrighted work and its respective copyright status;
a server application in communication with the business location identification process and the copyrighted work identification process that reviews the name of the at least one business, along with the copyrighted work, to determine the copyright licensing status of the at least one business; and
a copyright license database in communication with the server application, the copyright license database including copyright licensing information for a plurality of businesses.

2. The system of claim 1 wherein the device is a mobile phone having GPS capabilities for determining the location of the business.

3. The system of claim 1 wherein the device is a stationary device at the business location, employed for recording the copyrighted work.

4. The system of claim 1 further comprising a database of unlicensed businesses, containing information for businesses that do not have a license to perform copyrighted work.

5. The system of claim 1 wherein the copyrighted work identification process is employing using Shazam-type music recognition functions.

6. The system of claim 1 wherein the device is constructed and arranged to automatically monitor a particular business for its performances of copyrighted works.

7. The system of claim 6 wherein the user is rewarded for automatically monitoring a business.

8. A method for managing copyright licensing comprising:
recording a sample of a copyrighted work being performed at a business;
identifying the copyrighted work by name for determining whether the location is licensed to perform the copyrighted work;
identifying the business that is performing the copyrighted work by name and location; and
comparing the name of the business and the name of the copyrighted work to a copyright license database (CLD) to determine a licensing status of the business.

9. The method of claim 8 further comprising preparing a report detailing the licensing status of the business to thereby notify the business of any unlicensed performances.

10. The method of claim 9 further comprising transmitting the report to a database of unlicensed businesses (DUB), wherein the DUB comprises a listing of unlicensed businesses including the business address, GPS data, pictures and reports of infractions.

11. The method of claim 10 further comprising rewarding a user that has performed the step of recording of the copyrighted work.

12. The method of claim 8 further comprising initiating queries that allow a user to thereby identify the copyrighted work.

13. A copyright licensing database interconnected with a communication network for storing and managing copyright licensing comprising:
a copyright licensing status for each of a plurality of businesses, indicating the copyright licensing status for a business and a performance rights organization that licensed the copyright to the business; and
wherein the copyright licensing database is searchable and constructed and arranged to allow a user to provide additional information about the business through the communication network, thereby providing detailed information about the business to identify the business.

14. The copyright licensing database of claim 13 further comprising images provided by the user to determine the size of the business, thereby determining if the business is performing an infringing act.
